(19) United States
(12) Patent Application Publication
(10) Pub. No.: US 2011/0013810 A1
(43) Pub. Date: Jan. 20, 2011

(54) SYSTEM AND METHOD FOR AUTOMATIC TAGGING OF A DIGITAL IMAGE

(76) Inventors: Jimmy Engström, Malmo (SE); Bo Larsson, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/504,749

(22) Filed: Jul. 17, 2009

(51) Int. Cl. G06K 9/00

(52) U.S. Cl. 382/118

(57) ABSTRACT

A system for automatically tagging a digital image includes an electronic device having a face detector for receiving a digital image and determining whether the digital image contains at least one face. A faceprint generator generates a faceprint representing a face detected in the digital image. A matching operation attempts to match the faceprint to a reference data item to identify the face represented by the faceprint. If a match is found, a tag generator generates a text tag corresponding to the identity of the face represented by the faceprint, and may associate the tag with the digital image. If a match is not found, the faceprint may be transmitted with an identification request to an external electronic device, which performs the matching operation. Upon matching the faceprint to a reference data item, identification data identifying the face represented by the faceprint may be transmitted from the external electronic device to the originating electronic device. A text tag may then be generated based on the identification data.

### TECHNICAL FIELD OF THE INVENTION

The present invention relates to electronic devices that render a digital image, and more particularly to a system and methods for automatically tagging a digital image with an identification tag of subject persons depicted within the digital image.

### DESCRIPTION OF THE RELATED ART

Contemporary digital cameras typically include embedded digital photo album or digital photo management applications in addition to traditional image capture circuitry. Furthermore, as digital imaging circuitry has become less expensive, other portable devices, including mobile telephones, portable data assistants (PDAs), and other mobile electronic devices often include embedded image capture circuitry (e.g. digital cameras) and digital photo album or digital photo management applications in addition to traditional mobile telephony applications.

Popular digital photo management applications include several functions for organizing digital photographs. Tagging is one such function in which a user selects a digital photograph or portion thereof and associates a text item therewith. The text item is commonly referred to as a “text tag” and may provide an identification label for the digital image or a particular subject depicted within a digital image. Tags may be stored in a data file containing the digital image, including, for example, by incorporating the tag into the metadata of the image file. Additionally or alternatively, tags may be stored in a separate database which is linked to a database of corresponding digital images. A given digital photograph or image may contain multiple tags, and/or a tag may be associated with multiple digital images. Each tag may be associated with a distinct subject in a digital photograph, a subject may have multiple tags, and/or a given tag may be associated with multiple subjects whether within a single digital photograph or across multiple photographs.

For example, suppose a digital photograph is taken which includes a subject person who is the user's father. A user may apply to the photograph one or more tags associated with the digital image such as “father”, “family”, and “vacation” (e.g., if the user's father was photographed while on vacation). The digital photograph may include other subject persons each associated with their own tags. For example, if the photograph also includes the user's brother, the photograph also may be tagged “brother”. Other photographs containing an image of the user's father may share tags with the first photograph, but lack other tags. For example, a photograph of the user's father taken at home may be tagged as “father” and “family”, but not “vacation”. As another example, a vacation photograph including the user's mother may be tagged “family” and “vacation”, but not “father”.

It will be appreciated, therefore, that a network of tags may be applied to a database of digital images to generate a comprehensive organizational structure of the database. In particular, the tagging of individuals has become a useful tool for organizing photographs of friends, family, business associates, and other groups of people on social networking sites accessible via the Internet or other communications networks. Once the digital images in the database are fully associated with tags, they may be searched by conventional methods to access like photographs. In the example described above, a user who wishes to post photographs of his father on a social networking site may simply search a digital image database by the tag “father” to identify and access all the user's photographs of his father at once, which may then be posted on the site. Similarly, should the user desire to access and/or post photographs of his mother, the user may search the database by the tag “mother”, and so on.

Despite the increased popularity and usage of tagging to organize digital photographs, and tagging based on subject persons in particular, current systems for adding tags have proven deficient. One method of tagging is manual entry by the user. Manual tagging is time consuming and cumbersome if the database of digital images and contained subject persons is relatively large.

To overcome burdens associated with manual tagging, automatic tagging techniques have been developed which apply face recognition algorithms to identify subject persons depicted in a database of digital images. Face recognition tagging, however, also has proven deficient. Face recognition tagging requires a centralized database of reference subject images and/or subject identification data. Many users, particularly participants in social networking sites, would tend to feel uncomfortable having their images and associated identifying information stored in a centralized database to which strangers may have access. Although privacy and other access restrictions may be implemented, such restrictions are counter to face recognition identification, which requires a large reference database. Should a substantial portion of users refuse to participate in the centralized database over privacy concerns, the efficacy of face recognition tagging diminishes. In addition, face recognition accuracy remains limited, particularly as to a large reference database. There is a high potential that even modest “look-alikes” that share common overall features may be misidentified, and therefore mis-tagged. Mis-tagging, of course, would undermine the usefulness of any automatic tagging system.

### SUMMARY

Accordingly, there is a need in the art for an improved system and methods for the manipulation and organization of digital images (and portions thereof) that are rendered on an electronic device. In particular, there is a need in the art for an improved system and methods for automatically text tagging digital images containing faces rendered on an electronic device.

Accordingly, a system and methods for automatically text tagging a digital image includes an electronic device having a face detector for receiving a digital image and determining whether the digital image contains at least one face. A faceprint generator may generate a faceprint representing a face detected in the digital image. A tag generator may generate a tag corresponding to an identity of the face represented by the faceprint, and may associate the tag with the digital image.

In one embodiment, the electronic device may have a memory storing a plurality of reference data items, and a controller configured to match the faceprint to at least one of the plurality of reference data items to identify the face represented by the faceprint. If the faceprint is not matched with an internally stored referenced data item, such as a reference digital image or reference faceprint, the faceprint may be transmitted with an identification request to an external electronic device. To address privacy considerations, the external electronic device typically would be a device of one with whom the user has previously interacted. A comparable matching operation may be performed by the external electronic device. Upon matching the faceprint to a reference data item, identification data identifying the face represented in the faceprint may be transmitted from the external electronic device to the originating electronic device. A text tag may then be generated based on the identification data.

Therefore, according to one aspect of the invention, an electronic device comprises a face detector for receiving a digital image and determining whether the digital image contains at least one face, a faceprint generator for generating a faceprint representing a face detected in the digital image, and a tag generator for generating a tag corresponding to an identity of the face represented by the faceprint and for associating the tag with the digital image.

According to one embodiment of the electronic device, the electronic device further comprises a memory storing a plurality of reference data items, and a controller configured to match the faceprint to at least one of the plurality of reference data items to identify the face represented by the faceprint, wherein the tag generator generates a tag corresponding to the identified face.

According to one embodiment of the electronic device, the reference data items are reference digital images.

According to one embodiment of the electronic device, the reference data items are reference faceprints.

According to one embodiment of the electronic device, the electronic device further comprises a controller configured to generate an identification request for the faceprint, an external interface for transmitting the faceprint and identification request to an external electronic device, and for receiving identification data for the face represented by the faceprint from the external electronic device in response to the identification request, wherein the tag generator generates a tag corresponding to the received identification data.

According to one embodiment of the electronic device, the electronic device is a mobile telephone.

According to another aspect of the invention, an electronic device comprises a network interface for receiving a faceprint representing a face in a digital image from an external electronic device, a memory storing a plurality of reference data items, a controller configured to match the faceprint to one of the plurality of data items to identify the face represented by the faceprint and to generate identification data for the face represented by the faceprint, wherein the network interface transmits identification data for the face represented by the faceprint to the external electronic device.

According to one embodiment of the electronic device, the reference data items are reference digital images.

According to one embodiment of the electronic device, the reference data items are reference faceprints.

According to one embodiment of the electronic device, the external electronic device is a first external electronic device, and if the controller cannot match the faceprint, the controller is configured to generate an identification request for the unmatched faceprint. The faceprint and identification request are transmitted via the network interface to a second external electronic device, and identification data is received via the network interface for the face represented by the faceprint from the second external electronic device in response to the identification request. The identification data is transmitted via the network interface to the first external electronic device.

According to one embodiment of the electronic device, the tag generator associates the tag with the digital image by incorporating the tag into metadata of the digital image.

Another aspect of the invention is a method for generating a tag for a digital image with an electronic device comprising the steps of receiving a digital image in the electronic device, determining whether the digital image contains at least one face, generating a faceprint representing a face detected in the digital image, generating a tag corresponding to an identity of the face represented by the faceprint, and associating the tag with the digital image.

According to one embodiment of the method, the method further comprises storing a plurality of reference data items in a memory in the electronic device, and matching the faceprint to at least one of the plurality of reference data items to identify the face represented by the faceprint, wherein the tag generator generates a tag corresponding to the identified face.

According to one embodiment of the method, the reference data items are reference digital images.

According to one embodiment of the method, the reference data items are reference faceprints.

According to one embodiment of the method, the method further comprises generating an identification request for the faceprint, transmitting the faceprint and identification request to an external electronic device, receiving identification data for the face represented by the faceprint from the external electronic device in response to the identification request, and generating a tag corresponding to the received identification data.

According to one embodiment of the method, the method further comprises if the matching step does not result in identification of the face represented by the faceprint, generating an identification request for the unmatched faceprint, transmitting the faceprint and identification request to an external electronic device, receiving identification data for the face represented by the faceprint from the external electronic device in response to the identification request, and generating a tag corresponding to the received identification data.

According to one embodiment of the method, the method further comprises detecting a plurality of faces within the digital image, generating a plurality of faceprints representing respectively each of the plurality of faces detected in the digital image, storing a plurality of reference data items in a memory in the electronic device, matching a first faceprint from among the plurality of faceprints to at least one of the plurality of reference data items to identify a respective a face represented by the first faceprint, generating a tag corresponding to an identity of the face represented by the first faceprint, and associating the tag with the digital image.

According to one embodiment of the method, the method further comprises generating an identification request respectively for each unmatched faceprint from among the plurality of faceprints, transmitting each unmatched faceprint and each respective identification request to a first external electronic device, storing a plurality of reference data items in a memory in the first external electronic device, matching a second faceprint from among the plurality of faceprints to at least one of the plurality of reference data items stored in the first external electronic device to identify a respective face represented by the second faceprint, generating identification data for the face represented by the second faceprint, transmitting the identification data for the face represented by the second faceprint from the first external electronic device to the electronic device, and generating a tag corresponding to the received identification data for the second faceprint and associating the tag with the digital image.

According to one embodiment of the method, the method further comprises transmitting each unmatched faceprint and each respective identification request from the first external electronic device to a second external electronic device, storing a plurality of reference data items in a memory in the second external electronic device, matching a third faceprint from among the plurality of faceprints to at least one of the plurality of reference data items stored in the second external electronic device to identify a respective face represented by the third faceprint, generating identification data for the face represented by the third faceprint, transmitting the identification data for the face represented by the third faceprint from the second external electronic device to the first external electronic device, transmitting the identification data for the face represented by the third faceprint from the first external electronic device to the electronic device, and generating a tag corresponding to the received identification data for the third faceprint and associating the tag with the digital image.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic front view of a mobile telephone as an exemplary electronic device that includes a representative camera assembly.

FIG. 2 is a schematic rear view of the mobile telephone of FIG. 1.

FIG. 3 is a schematic block diagram of operative portions of the mobile telephone of FIG. 1.

FIG. 4 is a schematic block diagram of an exemplary tag generation application.

FIG. 5 is a flow chart depicting an exemplary method of generating a tag for a digital image.

FIG. 6A depicts an exemplary digital image, and FIG. 6B depicts exemplary faceprints representing the faces depicted in the digital image of FIG. 6A.

FIG. 7 depicts the exemplary digital image of FIG. 6A in which text tags are associated with each of the faces in the digital image.

FIG. 8 is a schematic diagram of a communications system in which the mobile telephone of FIG. 1 may operate.

FIG. 9 depicts the exemplary digital image of FIG. 7 in which one of the faces lacks a text tag.

FIG. 10 is a schematic diagram depicting an exemplary external matching operation to identify the untagged face in FIG. 9.

FIG. 11 depicts the exemplary digital image of FIG. 7 in which two of the faces lack a text tag.

FIG. 12 is a schematic diagram depicting an exemplary external matching operation to identify the untagged faces in FIG. 11.

FIG. 13 depicts an exemplary group photograph having faces that may be subjected to tagging.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

In the illustrated embodiments, a digital image may be rendered and manipulated as part of the operation of a mobile telephone. It will be appreciated that aspects of the invention are not intended to be limited to the context of a mobile telephone and may relate to any type of appropriate electronic device, examples of which include a stand-alone digital camera, a media player, a gaming device, or similar. For purposes of the description herein, the interchangeable terms “electronic equipment” and “electronic device” also may include portable radio communication equipment. The term “portable radio communication equipment,” which sometimes is referred to as a “mobile radio terminal,” includes all equipment such as mobile telephones, pagers, communicators, electronic organizers, personal digital assistants (PDAs), smartphones, and any communication apparatus or the like. All such devices may be operated in accordance with the principles described herein.

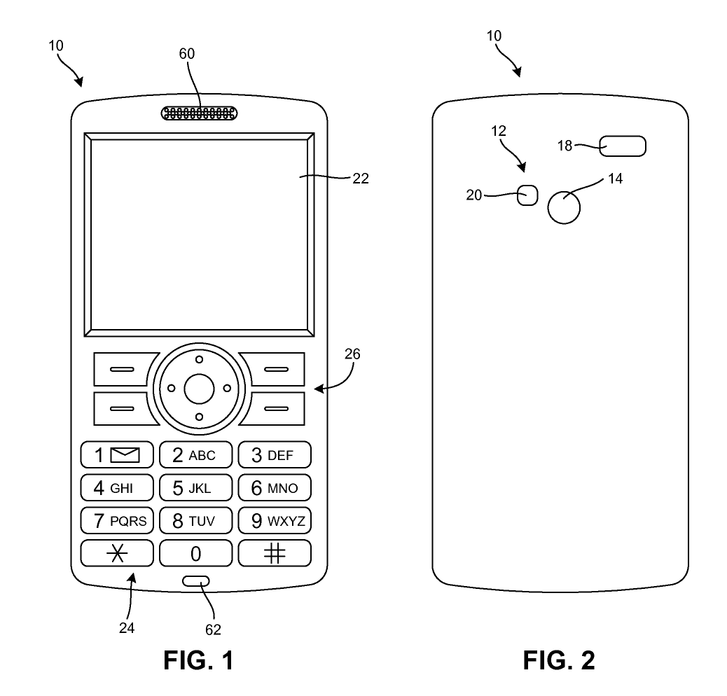

FIGS. 1 and 2 are schematic front and rear views respectively of an electronic device 10. The illustrated electronic device 10 is a mobile telephone, but, as stated above, may be any suitable electronic device. The exemplary mobile telephone is depicted as having a “block” or “brick” configuration, although the mobile telephone may have other configurations, such as, for example, a clamshell, pivot, swivel, and/or sliding cover configuration as are known in the art.

As seen in FIG. 2, the electronic device 10 includes a camera assembly 12 for taking digital still pictures and/or digital video clips. Although the description herein is made primarily in the context of manipulating digital still photographs, it will be appreciated that the concepts also may be applied to other digital images.

The camera assembly 12 may contain imaging optics 14 to focus light from a scene within the field-of-view of the camera assembly 12 onto a sensor 16 (not shown in this figure). The sensor converts the incident light into image data. The imaging optics 14 may include various optical components, such as a lens assembly and components that supplement the lens assembly (e.g., a protective window, a filter, a prism, and/or a mirror). The imaging optics 14 may be associated with focusing mechanics, focusing control electronics (e.g., a multi-zone autofocus assembly), optical zooming mechanics, and the like. Other camera assembly 12 components may include a flash 18 to provide supplemental light during the capture of image data for a photograph, and a light meter 20.

Referring again to FIG. 1, a display 22 may function as an electronic viewfinder for the camera assembly 12. In addition, as part of an interactive user interface, a keypad 24 and/or buttons 26 may be associated with aspects of the camera system 12. For example, one of the keys from the keypad 24 or one of the buttons 26 may be a shutter key that the user may depress to command the taking of a photograph. One or more keys also may be associated with entering a camera mode of operation, such as by selection from a conventional menu or by pushing a dedicated button for the camera function. The camera assembly may possess other features, such as, for example, an optical viewfinder (not shown), and any other components commonly associated with digital cameras. It will be appreciated that the keypad 24 and buttons 26 also may be used to provide a variety of input operations as is conventional.

Typically, the display 22, which may function as the viewfinder of the camera assembly, is on an opposite side of the electronic device 10 from the imaging optics 14. In this manner, a user may point the camera assembly 12 in a desired direction and view a representation of the field-of-view of the camera assembly 12 on the display 22. The field-of-view of the camera assembly 12 may be altered with characteristics of the imaging optics 14 and optical settings, such as an amount of zoom. The camera field-of-view may be displayed in the camera viewfinder (display 22 in this embodiment), which may then be photographed.

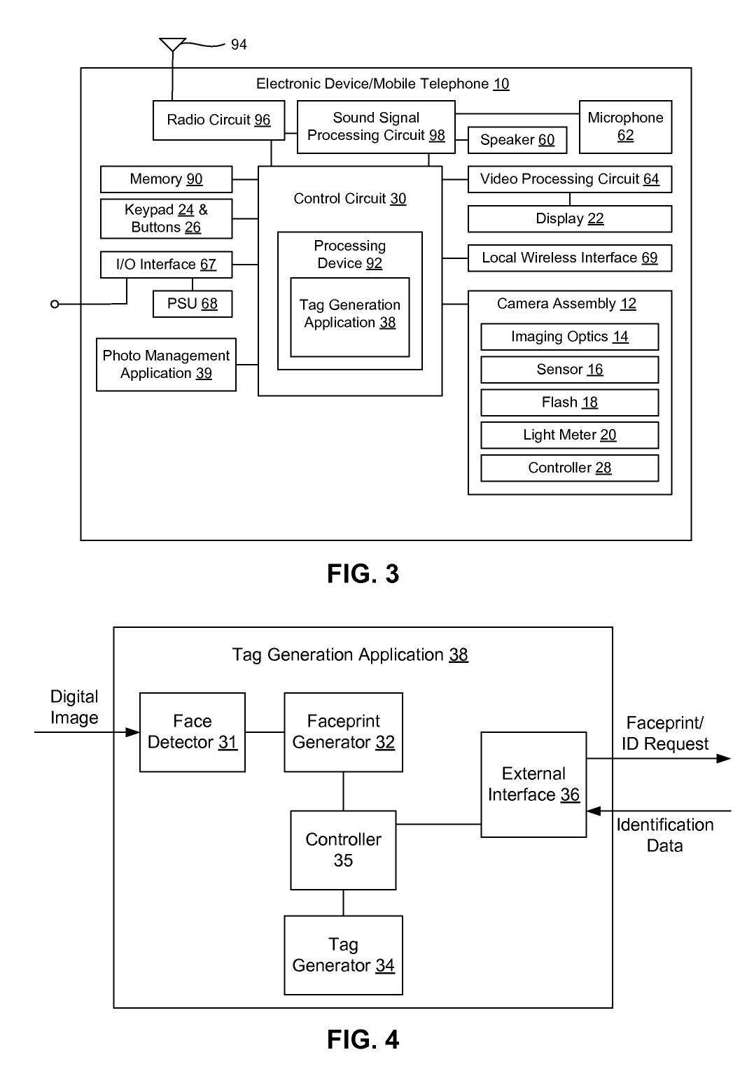

FIG. 3 is a schematic block diagram of operative portions of the electronic device/mobile telephone 10. The electronic device 10 may include the camera assembly 12, as described above, having imaging optics 14, sensor 16, flash 18, and light meter 20. Another component of the camera assembly 12 may be an electronic controller 28 that controls operation of the camera assembly 12. The controller 28 may be embodied, for example, as a processor that executes logical instructions that are stored by an associated memory, as firmware, as an arrangement of dedicated circuit components, or as a combination of these embodiments. Thus, methods of operating the camera assembly 12 may be physically embodied as executable code (e.g., software) that is stored on a machine readable medium or may be physically embodied as part of an electrical circuit. In another embodiment, the functions of the electronic controller 28 may be carried out by a control circuit 30 that is responsible for overall operation of the electronic device 10. In this case, the controller 28 may be omitted. In another embodiment, camera assembly 12 control functions may be distributed between the controller 28 and the control circuit 30.

In one embodiment, images to be tagged in accordance with the principles described herein are taken with the camera assembly 12. It will be appreciated, however, that the digital images to be tagged as described herein need not come from the camera assembly 12. For example, digital images may be stored in and retrieved from a memory 90. In addition, digital images may be accessed from an external or network source via any conventional wired or wireless network interface. Accordingly, the precise of source of the digital image to be tagged may vary.

Referring again to FIG. 3, the electronic device 10 may include a primary control circuit 30 that is configured to carry out overall control of the functions and operations of the device 10. The control circuit 30 may include a processing device 92, such as a CPU, microcontroller or microprocessor.

Among their functions, to implement the features of the present invention, the control circuit 30 and/or processing device 92 may comprise a controller that may execute program code stored on a machine-readable medium embodied as tag generation application 38. Application 38 may be a stand-alone software application or form a part of a software application that carries out additional tasks related to the electronic device 10. It will be apparent to a person having ordinary skill in the art of computer programming, and specifically in application programming for mobile telephones, servers or other electronic devices, how to program an electronic device to operate and carry out logical functions associated with the application 38. Accordingly, details as to specific programming code have been left out for the sake of brevity. In addition, application 38 and the various components described below may be embodied as hardware modules, firmware, or combinations thereof, or in combination with software code. Also, while the code may be executed by control circuit 30 in accordance with exemplary embodiments, such controller functionality could also be carried out via dedicated hardware, firmware, software, or combinations thereof, without departing from the scope of the invention.

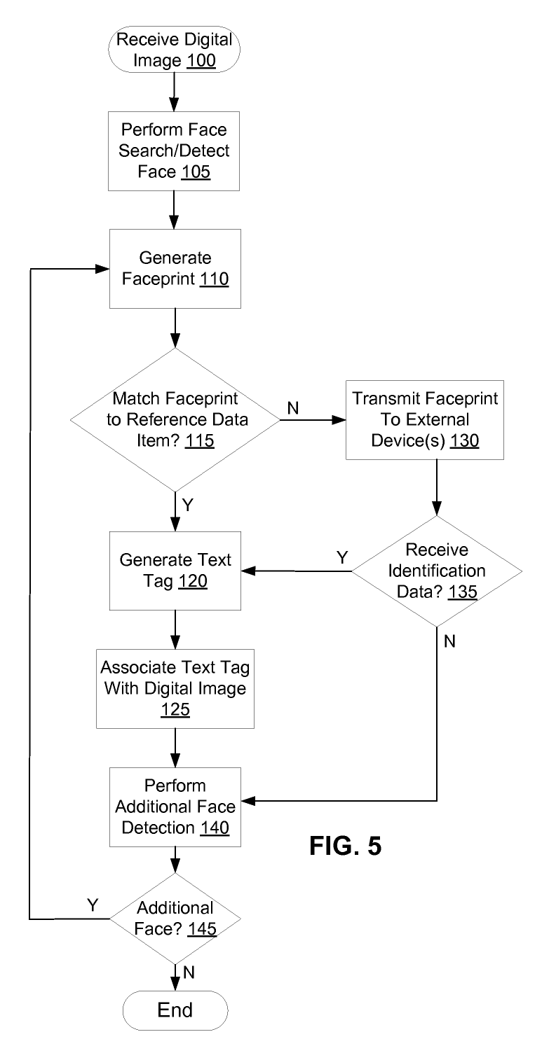

FIG. 4 depicts a schematic block diagram of an exemplary tag generation application 38, and FIG. 5 depicts an associated flowchart chart depicting an overview of an exemplary method of tagging a digital image. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention. The method depicted in FIG. 5 represents an overview, and additional details are provided in connection with various examples set forth below.

Referring to FIGS. 4 and 5, the exemplary tagging method may begin at step 100 at which a digital image is received by the application 38. As stated above, the image may be received by taking a digital photograph with the camera assembly of the electronic device, by retrieving the digital image from an internal memory, or by receiving the digital image from an external or network source. Once the digital image is received, at step 105 the image may be searched using a face detection function to determine whether one or more faces are present in the digital image. For purposes of this example, it is presumed that the face search detects the presence of at least one face. For the face detected by the initial search for faces, at step 110 a “faceprint” may be generated. As seen in FIG. 4, as part of application 38, the initial face detection search may be performed by a face detector 31, and the faceprint may be generated by a faceprint generator 32. It will be appreciated that the face detection search and faceprint generation may be combined into a single component or operation.

As used herein, the term “faceprint” denotes a representation of a face depicted in the digital image that would occupy less storage capacity than the broader digital image itself. For example, the faceprint may be a mathematical description or model of a face that describes facial curvatures and features sufficient to identify the face. Mathematical descriptions or modeling of faces is known in the art and may be used in a variety image manipulation applications. As another example, the faceprint may be a thumbnail representation of the face removed from the broader digital image, or other partial digital image depicting facial features. The faceprint could be the entire digital image, but such is not preferred due to the processing capacity required to manipulate full digital images. Generally, a faceprint corresponds to a digital representation of a face, apart from the digital image in which the face is depicted, that is sufficient to identify the depicted individual corresponding to the face. By representing the face as a mathematical description, model, or partial image in the form of a faceprint, an individual depicted in the digital image may be identified without processing the entire digital image. The system described herein, therefore, provides for efficient use of system resources and processing capacity without sacrificing accuracy in identifying individuals depicted in a digital image.

After the faceprint is generated, the method may proceed to step 115, at which an attempt is made to match the faceprint to one of a plurality of reference data items stored internally within the electronic device. By this matching operation, an attempt is made to identify the individual represented by the faceprint by determining whether the individual's face was previously identified or tagged in connection with another digital image stored internally in the electronic device. For example, the reference data items may be stored previously tagged digital images from which the faceprint may be matched. Alternatively, the reference data items may be a database of stored faceprints generated from other digital images.

If at step 115 a match is found, at step 120 at text tag may be generated for the face represented by the faceprint. At step 125, the text tag may be associated with the digital image. As shown in FIG. 4, for example, application 38 may include a tag generator 34 and a controller 35. The controller 35 may perform the faceprint matching operation which attempts to identify the individual or face represented by the faceprint. If a match is found, the tag generator 34 may generate a text tag (such as a name of the person corresponding to the faceprint) and associate the tag with the digital image. It will be appreciated that the operations of faceprint matching, tag generation, and/or tag association with the digital image may be combined or separated into component modules in a variety of ways, and the configuration of FIG. 4 represents one such example.

Referring again to FIG. 5, if at step 115 the individual or face represented by the faceprint cannot be identified by an internal matching operation, at step 130 the faceprint may be transmitted externally to an external electronic device, which may then perform an external matching operation. Additional details regarding external matching are explained with reference to the examples below. In general, the faceprint may be transmitted to one or more other external electronic devices, each of which may contain its own database of stored reference data items. The transmission of the faceprint print may include an identification (ID) request requesting that the external electronic device(s) attempt to identify the face represented by the faceprint. The external electronic device(s) may perform a matching operation similar to that described above, by which a plurality of reference data items, such as reference digital images or reference faceprints, are employed to attempt to identify the face represented by the faceprint. If a match is found, at step 135 identification data may be received from the external electronic device. As seen in FIG. 4, the controller 35 may cause the faceprint/ID request to be transmitted externally via an external interface 36. The external interface 36 also may receive the identification data, which may then be forwarded to the controller 35 and tag generator 34.

When an external match is found, therefore, the method may then return to steps 120 and 125 of FIG. 5, by which a text tag may be generated for the face represented by the faceprint and associated with the digital image. If no external match is found, the method proceeds without automatic tag generation. In such a case, a user may perform a manual or other tagging operation as are known in the art, or simply leave the face untagged within the digital image.

The above method may be performed as to each face contained in the digital image. At step 140, therefore, an additional face detection operation may be performed, and at step 145 a determination may be made as to whether an additional face is detected in the digital image. If so, the method may return to step 110 so faceprint generation, faceprint matching, and tag generation and association may be performed as to each face detected in the digital image.

As stated above, FIG. 5 represents an overview of an exemplary method for tagging a digital image. Additional details will now be described with respect to the following examples. The examples are provided for illustrative purposes to explain variations and specific embodiments, and it will be understood that the examples are not intended to limit the scope of the invention.

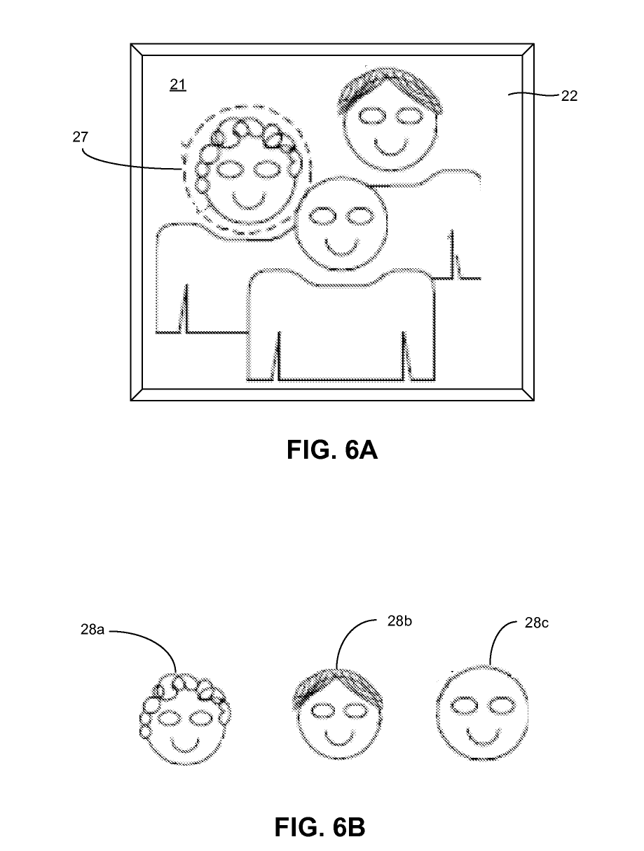

FIG. 6A depicts an exemplary digital image 21 as it may be displayed on display 22 of an electronic device. The digital image 21 may be generated by the camera assembly of the electronic device, retrieved from a memory located within the electronic device, received from an external or network storage device or source, or by any conventional means. The digital image includes faces 27, one of which is indicated by the dashed circle. It will be appreciated that the dashed circle ordinarily would not actually appear in the display 22, but it is shown in the figure for convenient reference. The digital image in this example contains three faces, although any number of faces may be processed.

FIG. 6B depicts exemplary faceprints 28a-c corresponding to each of the faces 27 contained in the digital image of FIG. 6A. In the figure, the faceprints are depicted for simplicity as thumbnail or partial images of the faces extracted from the digital image 21. As stated above, however, to decrease the file size of the faceprints, the faceprints may comprise mathematical descriptions or models of the faces that are sufficient to identify the faces without having the data size of a conventional digital image, or even of a thumbnail portion thereof.

Once each of the faceprints has been generated, a controller or other processing device may compare a faceprint to a database containing a plurality of reference data items. The reference data items may be reference digital images or stored faceprints generated previously. For example, the controller 30 or 35 may compare a faceprint, such as faceprint 28a, to reference data items stored internally in the electronic device, such as a memory 90 of electronic device 10 (see FIGS. 3 and 4).

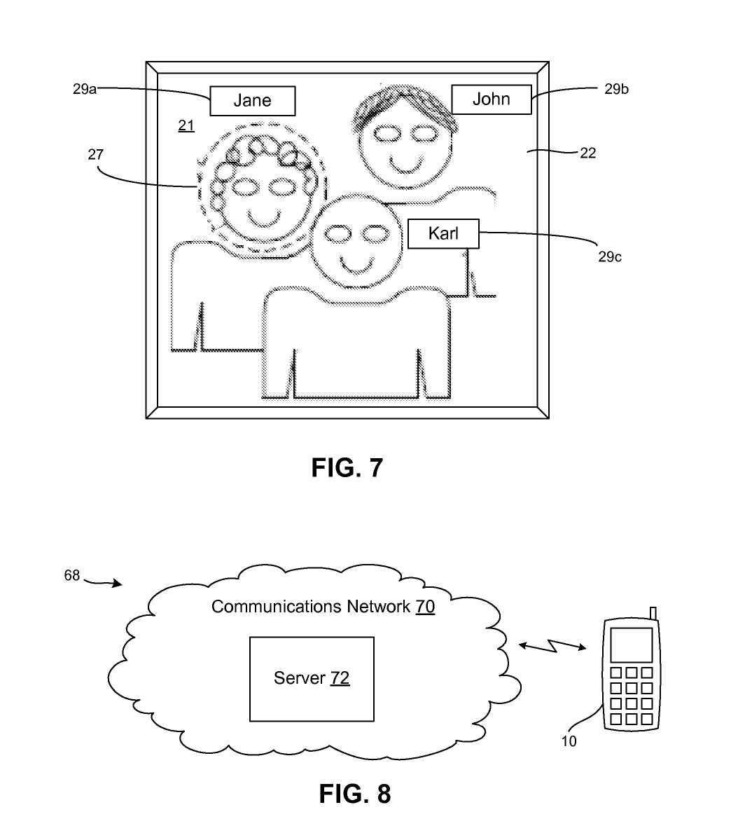

In this first example, it is presumed that each of the faceprints 28a-c may be matched to a reference data item contained in the electronic device. In other words, each individual whose face is represented by each respective faceprint may be identified. For each match, an identifying text tag may be generated. FIG. 7 depicts the digital image 21 in which text tags 29a-c respectively identifying each of the faces represented by faceprints 28a-c are shown for Jane, John, and Karl. For convenience, throughout the various examples reference numerals employing the letters “a”, “b”, and “c” are used respectively to refer to like features associated with exemplary persons Jane, John, and Karl.

Although the text tags appear as labels in the figure, it will be appreciated that ordinarily the tags would not appear in the digital image 21 (although they can be in one embodiment). Rather, the tags may be incorporated or otherwise associated with an image data file for the digital image 21. For example, the tags may be incorporated into the metadata for the image file, as is known in the art. Additionally or alternatively, the tags may be stored in a separate database having links to the associated image files. Tags may then be accessed and searched to provide an organizational structure to a database of stored images. For example, as shown in FIG. 3 the electronic device 10 may include a photo management application 39, which may be a standalone function, incorporated into the camera assembly, incorporated into the tag generation application 38, or otherwise present in the electronic device 10. If a user desires to group photographs of Jane (such as for printing, posting on a social networking site, sharing with a friend, or other manipulation), a user many execute the application 39 by any conventional means. Application 39 may include a search function that permits a user to enter a search query for a tag, “Jane” for example, upon which all digital images tagged with the “Jane” tag are grouped for further manipulation. Similar querying and grouping operations may be performed for any given text tag.

It will be appreciated that a database of digital images or other reference data items in any given electronic device may be limited. Accordingly, an internal matching operation may not be sufficient to identify an individual or face corresponding to each generated faceprint. In such a case, an external matching operation may be initiated.

As depicted in FIG. 8, the electronic device (mobile telephone) 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software. The communications system may be employed to perform external matching operations among participant user devices.

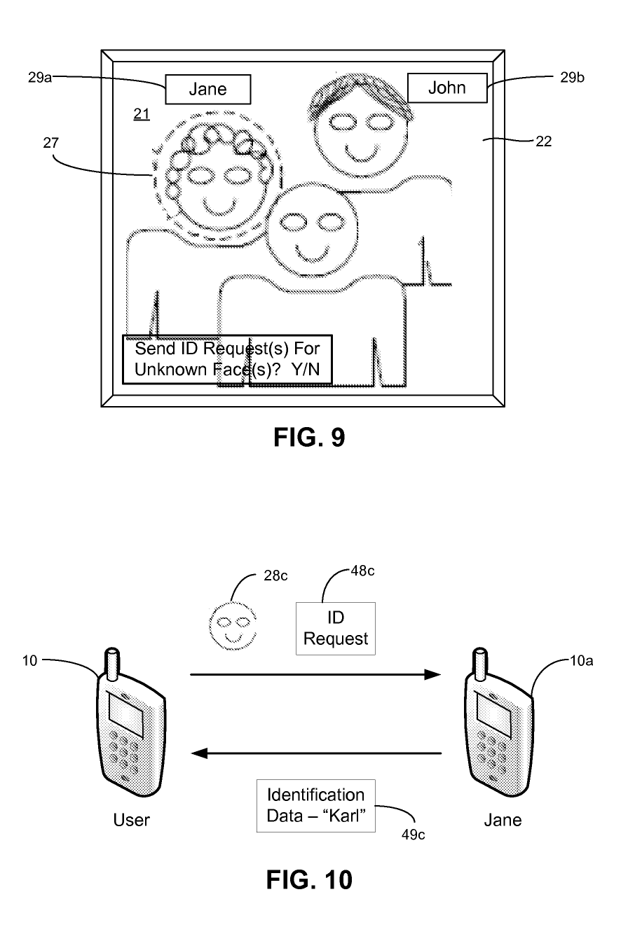

FIG. 9 depicts an example modified from the example of FIG. 7. As seen in FIG. 9, one of the faces has not been identified, as shown in the lack of a text tag 29c associated with Karl. An external matching operation, therefore, may be employed to identify the unknown face. In one embodiment, as seen in FIG. 9 a prompt may be employed by which a user may select whether or not to initiate an external matching operation.

FIG. 10 is a diagram depicting an exemplary external matching operation to identify the unknown face depicted in FIG. 9. In this example, the user electronic device 10 transmits the faceprint 28c generated for the unknown face to an external electronic device 10a. In addition, electronic device 10 generates and transmits an associated identification (ID) request 48c, which constitutes an electronic request that the device 10a attempt to match the faceprint 28c with reference data items contained in device 10a. In this example, the electronic device 10a is the device used by Jane, an identified face in the digital image 21. The selection of a device of an identified user is reasonable because it is more probable that the device of Jane, who appears in the digital image with the unknown face, be apt to identify the unknown face than a device of a user who is not in the photograph. (A similar example could involve an electronic device 10b of user John, but only one transmission is shown for simplicity.) In one embodiment, the device 10a may employ a prompt by which Jane may provide a user input of whether to accept the ID request. The device 10a of Jane may perform a matching operation as described above. In this example it is presumed Jane's device is able to identify the face corresponding to faceprint 28c. Device 10a, therefore, transmits identification data 49c that identifies the unknown face as Karl. From the identification data 49c, device 10 may then generate a text tag 29c for Karl, such as that depicted in FIG. 7.

Although the identification request was sent to Jane's device 10a as a known face in the digital image, such need not be the case. An external matching device may be selected by means other than based upon which faces appear in the digital image. For example, one or more external matching devices may be selected based on a contact list stored in the electronic device 10. A selection from a broader contact list may be suitable, for example, in the event device 10 is unable to match and identify any of the faceprints generated based on the digital image.

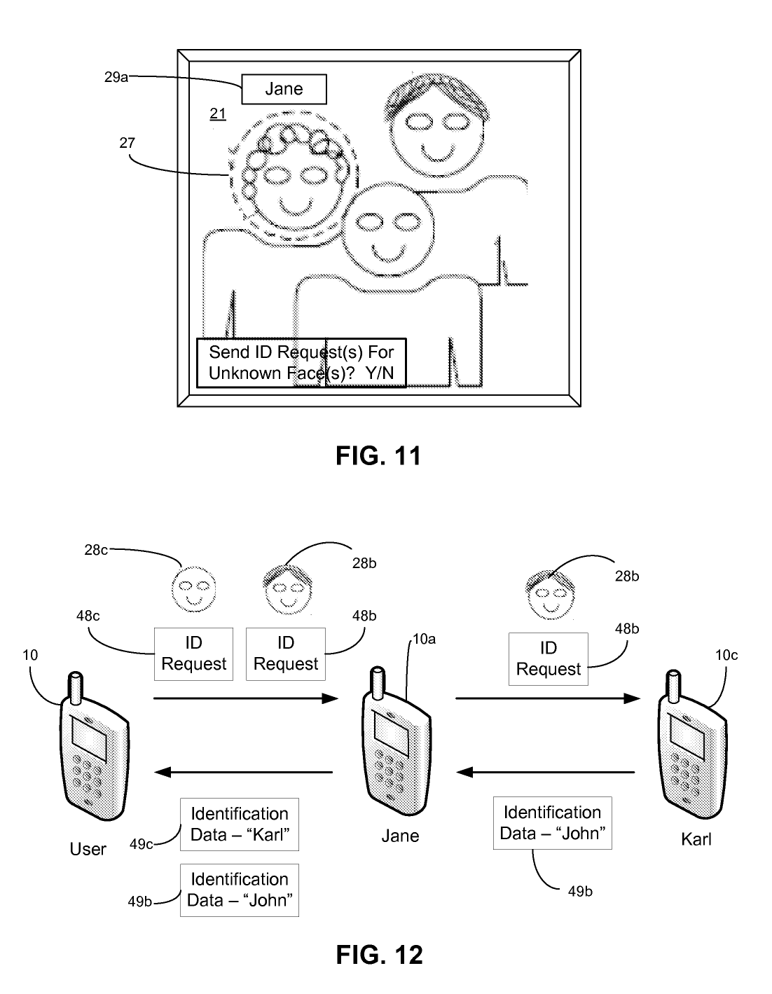

Multiple external matching operations also may be performed. FIG. 11 depicts an example modified from the example of FIG. 7 in which two of the faces have not been identified, as shown in the lack of a text tags 29b and 29c associated respectively with John and Karl. Multiple external matching operations, therefore, may be employed to identify the unknown faces.

FIG. 12 is a diagram depicting exemplary multiple external matching operations to identify the multiple unknown faces depicted in FIG. 11. In this example, the user electronic device 10 transmits the faceprints 28b and 28c generated for the unknown faces to a first external electronic device 10a. In addition, electronic device 10 transmits respective identification (ID) requests 48b and 48c, which constitute electronic requests that the device 10a attempt to match the faceprints 28b and 28c with reference data items contained in device 10a. As in the previous example, in this example the electronic device 10a is the device used by Jane, an identified face in the digital image 21, which although perhaps preferred, need not be the case. Again, in one embodiment, the device 10a may employ a prompt by which Jane may provide a user input of whether to accept the ID request. In this example, the device 10a of Jane is able to identify the face corresponding to faceprint 28c (Karl), but is not able to identify the face corresponding to faceprint 28b.

Device 10a of Jane, therefore, transmits the unmatched faceprint 28b along with the ID request 48b to a second external electronic device 10c. In this example, the device 10c is the device of Karl because, similar to Jane's device, it is more probable that a device used by Karl would be able to identify the unknown faceprint than a device of a user who does not appear in the digital image. Similar to the above, in one embodiment, the device 10c may employ a prompt by which Karl may provide a user input of whether to accept the ID request. The device 10c of Karl may perform a matching operation as described above. In this example, it is presumed the device 10c is able to identify the face corresponding to faceprint 28b. Device 10c, therefore, generates and transmits identification data 49b to Jane's first external electronic device 10a that identifies the unknown face as John. Device 10a, in turn, transmits both the identification data 49c for Karl and identification data 49b for John back to the original user electronic device 10. From the identification data 49b and 49c, device 10 may then generate a text tag 29b for John and 29c for Karl, such as those depicted in FIG. 7.

In one embodiment, intermediate tagging requests or information may be stored in an intervening electronic device. For example, in the tagging operation of FIG. 12, Jane's electronic device 10a may store the ID request 48b and/or the Identification Data 49b associated with “John”. In such a case, subsequent tagging of a picture containing John may be performed by Jane's device without having to transmit the additional ID request shown in FIG. 12.

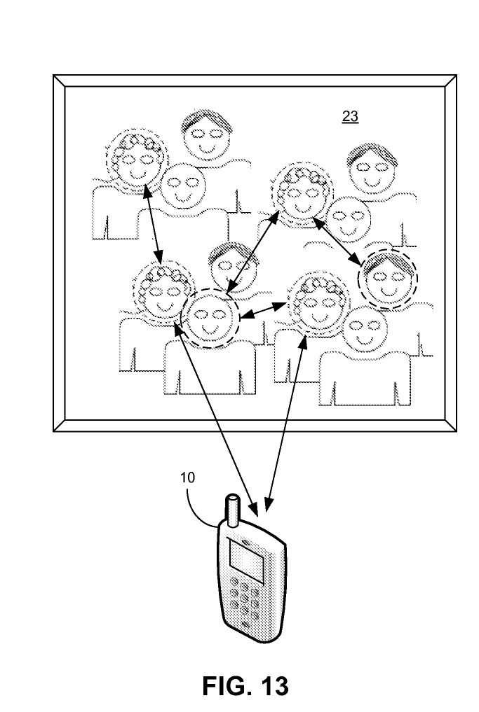

From these examples, it can be appreciated that text tags automatically may be generated for many faces in a group photograph. FIG. 13 depicts a group photograph 23 of numerous individuals either being taken or accessed by a user electronic device 10. The double arrows represent both linear and branching pairs of faceprint/ID request transmissions and return transmissions of identification data for unknown faces, comparable to the transmission pairs of FIGS. 10 and 12, ultimately resulting in the transmission of the identification data for all unknown faces back to the user electronic device 10. From such identification data, tags for all the faces in the group photograph may be generated and associated with the digital image 23.

As is apparent, the system and methods described herein have advantages over conventional tagging systems. As an automatic tagging system, the present invention avoids the time consuming and cumbersome nature of manual tagging. The described system and methods also lack the deficiencies associated with conventional automatic tagging systems based on comprehensive face recognition. The described system essentially operates as a peer-to-peer system without the need of any centralized server or database of reference images. Furthermore, each participant would tend to know one or more other participants because tag requests are sent primarily to those identified from the subject digital images. The described system, therefore, presents reduced privacy concerns as compared to more centralized systems because tagging is performed essentially over a network of common or shared “friends” who have had previous interactions. Relatedly, the system does not present opportunities for queries to be submitted by unwanted outsiders, and no broadcasts of ID requests occur which might annoy those who do not wish to participate in the system. Participants, therefore, would tend to find the described system more trustworthy as compared to conventional automatic tagging systems. Accuracy also is increased as compared to conventional automatic tagging systems because faceprint matching is limited to those likely to appear in digital images shared by participants in a “friends” or social networking group.

Although the invention has been described with reference to a digital photograph, the embodiments may be implemented with respect to other categories of digital images. For example, similar principles may be applied to a moving digital image, a webpage downloaded from the Internet or other network, or any other digital image. In addition, although the invention has been described with respect to tagging digital images containing faces of people, similar principles may be applied to other subject matter depicted in digital images, such as animals and various objects. In such cases, an “object-print” may be generated and processed in a manner comparable to the processing of faceprints as described above.

Referring again to FIG. 3, additional components of the mobile telephone 10 will now be described. For the sake of brevity, generally conventional features of the mobile telephone 10 will not be described in great detail herein.

The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia messaging service), image files, video files, audio files, ring tones, streaming audio, streaming video, data feeds (including podcasts) and so forth. Processing such data may include storing the data in the memory 90, executing applications to allow user interaction with data, displaying video and/or image content associated with the data, outputting audio sounds associated with the data and so forth.

The mobile telephone 10 may include an antenna 94 coupled to a radio circuit 96. The radio circuit 96 includes a radio frequency transmitter and receiver for transmitting and receiving signals via the antenna 94 as is conventional. In accordance with the present invention, the radio circuit and antenna may be employed to transmit and receive faceprints, ID requests, and/or identification data over the communications network of FIG. 8 as described above.

The mobile telephone 10 further includes a sound signal processing circuit 98 for processing audio signals transmitted by and received from the radio circuit 96. Coupled to the sound processing circuit are a speaker 60 and microphone 62 that enable a user to listen and speak via the mobile telephone 10 as is conventional (see also FIG. 1).

The display 22 may be coupled to the control circuit 30 by a video processing circuit 64 that converts video data to a video signal used to drive the display. The video processing circuit 64 may include any appropriate buffers, decoders, video data processors and so forth. The video data may be generated by the control circuit 30, retrieved from a video file that is stored in the memory 90, derived from an incoming video data stream received by the radio circuit 96 or obtained by any other suitable method.

The mobile telephone 10 also may include a local wireless interface 69, such as an infrared transceiver, RF adapter, Bluetooth adapter, or similar component for establishing a wireless communication with an accessory, another mobile radio terminal, computer or another device. In embodiments of the present invention, the local wireless interface 69 may be employed for short-range wireless transmission of faceprints, ID requests, and/or identification data among devices in relatively close proximity.

The mobile telephone 10 also may include an I/O interface 67 that permits connection to a variety of conventional I/O devices. One such device is a power charger that can be used to charge an internal power supply unit (PSU) 68. In embodiments of the present invention, I/O interface 67 may be employed for wired transmission of faceprints, ID requests, and/or identification data between devices sharing a wired connection.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. An electronic device comprising:
a face detector for receiving a digital image and determining whether the digital image contains at least one face;
a faceprint generator for generating a faceprint representing a face detected in the digital image; and
a tag generator for generating a tag corresponding to an identity of the face represented by the faceprint and for associating the tag with the digital image.

2. The electronic device of claim 1, further comprising:
a memory storing a plurality of reference data items; and
a controller configured to match the faceprint to at least one of the plurality of reference data items to identify the face represented by the faceprint;
wherein the tag generator generates a tag corresponding to the identified face.

3. The electronic device of claim 2, wherein the reference data items are reference digital images.

4. The electronic device of claim 2, wherein the reference data items are reference faceprints.

5. The electronic device of claim 1 further comprising:
a controller configured to generate an identification request for the faceprint; and
an external interface for transmitting the faceprint and identification request to an external electronic device, and for receiving identification data for the face represented by the faceprint from the external electronic device in response to the identification request;
wherein the tag generator generates a tag corresponding to the received identification data.

6. The electronic device of claim 1, wherein the electronic device is a mobile telephone.

7. An electronic device comprising:
a network interface for receiving a faceprint representing a face in a digital image from an external electronic device;
a memory storing a plurality of reference data items;
a controller configured to match the faceprint to one of the plurality of data items to identify the face represented by the faceprint, and to generate identification data for the face represented by the faceprint;
wherein the network interface transmits identification data for the face represented by the faceprint to the external electronic device.

8. The electronic device of claim 7, wherein the reference data items are reference digital images.

9. The electronic device of claim 7, wherein the reference data items are reference faceprints.

10. The electronic device of claim 7, wherein the external electronic device is a first external electronic device, and if the controller cannot match the faceprint, the controller is configured to generate an identification request for the unmatched faceprint;
wherein the faceprint and identification request are transmitted via the network interface to a second external electronic device, and identification data is received via the network interface for the face represented by the faceprint from the second external electronic device in response to the identification request; and
wherein the identification data is transmitted via the network interface to the first external electronic device.

11. The electronic device of claim 1, wherein the tag generator associates the tag with the digital image by incorporating the tag into metadata of the digital image.

12. A method for generating a tag for a digital image with an electronic device comprising the steps of:
receiving a digital image in the electronic device;
determining whether the digital image contains at least one face;
generating a faceprint representing a face detected in the digital image;
generating a tag corresponding to an identity of the face represented by the faceprint; and
associating the tag with the digital image.

13. The method of generating a tag of claim 12, further comprising:
storing a plurality of reference data items in a memory in the electronic device; and
matching the faceprint to at least one of the plurality of reference data items to identify the face represented by the faceprint;
wherein the tag generator generates a tag corresponding to the identified face.

14. The method of generating a tag of claim 13, wherein the reference data items are reference digital images.

15. The method of generating a tag of claim 13, wherein the reference data items are reference faceprints.

16. The method of generating a tag of claim 12, further comprising:
generating an identification request for the faceprint;
transmitting the faceprint and identification request to an external electronic device;
receiving identification data for the face represented by the faceprint from the external electronic device in response to the identification request; and
generating a tag corresponding to the received identification data.

17. The method of generating a tag of claim 13, further comprising:
if the matching step does not result in identification of the face represented by the faceprint, generating an identification request for the unmatched faceprint;
transmitting the faceprint and identification request to an external electronic device;
receiving identification data for the face represented by the faceprint from the external electronic device in response to the identification request; and
generating a tag corresponding to the received identification data.

18. The method for generating a tag of claim 12, further comprising:
detecting a plurality of faces within the digital image;
generating a plurality of faceprints representing respectively each of the plurality of faces detected in the digital image;
storing a plurality of reference data items in a memory in the electronic device;
matching a first faceprint from among the plurality of faceprints to at least one of the plurality of reference data items to identify a respective a face represented by the first faceprint;
generating a tag corresponding to an identity of the face represented by the first faceprint; and
associating the tag with the digital image.

19. The method of generating a tag of claim 18, further comprising:
generating an identification request respectively for each unmatched faceprint from among the plurality of faceprints;
transmitting each unmatched faceprint and each respective identification request to a first external electronic device;
storing a plurality of reference data items in a memory in the first external electronic device;
matching a second faceprint from among the plurality of faceprints to at least one of the plurality of reference data items stored in the first external electronic device to identify a respective face represented by the second faceprint;
generating identification data for the face represented by the second faceprint;
transmitting the identification data for the face represented by the second faceprint from the first external electronic device to the electronic device; and
generating a tag corresponding to the received identification data for the second faceprint and associating the tag with the digital image.

20. The method of generating a tag of claim 19, further comprising:
transmitting each unmatched faceprint and each respective identification request from the first external electronic device to a second external electronic device;
storing a plurality of reference data items in a memory in the second external electronic device;
matching a third faceprint from among the plurality of faceprints to at least one of the plurality of reference data items stored in the second external electronic device to identify a respective a face represented by the third faceprint;
generating identification data for the face represented by the third faceprint;
transmitting the identification data for the face represented by the third faceprint from the second external electronic device to the first external electronic device;
transmitting the identification data for the face represented by the third faceprint from the first external electronic device to the electronic device; and
generating a tag corresponding to the received identification data for the third faceprint and associating the tag with the digital image.
